(19) United States
(12) Patent Application Publication
(10) Pub. No.: US 2015/0043320 A1
(43) Pub. Date: Feb. 12, 2015

(54) OPTICAL PICKUP AND OPTICAL DISC DEVICE

(71) Applicant: Funai Electric Co., Ltd., Osaka (JP)

(72) Inventors: Mitsuyoshi SASABE, Daito-shi (JP); Mio KOGA, Daito-shi (JP); Mika HAMAOKA, Daito-shi (JP)

(21) Appl. No.: 14/340,723

(22) Filed: Jul. 25, 2014

(30) Foreign Application Priority Data
Aug. 9, 2013 (JP) 2013-166428

(51) Int. Cl. G11B 7/1395; G11B 7/095; G11B 7/1353; G11B 7/09

(52) U.S. Cl. CPC G11B 7/1395; G11B 7/0946; G11B 7/095; G11B 7/1353
USPC 369/47.49

(57) ABSTRACT

An optical pickup is configured such that light split by a light-splitting element is received by light-receiving elements provided on a light-receiving surface of a light-receiving unit, has on the light-receiving surface of the light-receiving unit quartered light-receiving portions that detect position-adjustment light and configured by equal quartering so as to be arranged in two dimensions, and in which the position of the light-splitting element is adjusted based on the position-adjustment light received by each of the quartered light-receiving portions.

### BACKGROUND OF THE INVENTION

1. Field of the Invention

The present invention relates to an optical pickup and an optical disc device and particularly to an optical pickup and an optical disc device equipped with a light-splitting element that splits light returned from an optical disc.

2. Description of the Related Art

Optical disc devices such as BD players and DVD players are equipped with an optical pickup that irradiates an optical disc with light and detects light reflected off the optical disc (return light). Such an optical pickup utilizes return light to control the optical pickup (tracking and focusing) and to acquire information. The optical pickup is equipped with a light-splitting element that splits the return light into signal light for use in control and signal light for use in information acquisition. The light split by the light-splitting element is received respectively by individual light-receiving elements (for example, see Japanese Patent Application Laid-Open Publication No. 2011-23054).

The optical pickup described in Japanese Patent Application Laid-Open Publication No. 2011-23054 is equipped with an integrated optical element (the light-splitting element in the present invention) and a photodetector that arrays a plurality of light-receiving units on a plane. The optical pickup splits the return light with the integrated optical element and receives the split light (diffracted light) on the plurality of light-receiving units, thereby obtaining a control signal. Furthermore, the optical pickup is equipped with the light-receiving unit of a dummy photodetector and uses detection signals detected by the light-receiving unit of the dummy photodetector and one light-receiving unit among the plurality of light-receiving units to position the integrated optical element and the photodetector such that the center thereof coincides with the center of the return light.

By performing this sort of adjustment, the light beams split by the integrated optical element (split light) are accurately directed onto their corresponding light-receiving units, and control signals and information acquisition signals are accurately received, thus making it possible for the optical pickup to be operated with a high degree of precision.

However, in cases where an optical pickup is assembled using the configuration of Japanese Patent Application Laid-Open Publication No. 2011-23054, the optical axis of the return light can be overlaid on the center of the integrated optical element and the photodetector, but variations in the distance between the integrated optical element and the photodetector in the direction of the optical axis will remain unadjusted.

When the distance between the integrated optical element and the photodetector in the direction of the optical axis changes, the split light may shift away from the light-receiving units, so there are cases in which the control signal and information acquisition signal can no longer be accurately received. Moreover, even if control signals and information acquisition signals can be received accurately under normal circumstances, if the attitude of the optical pickup fluctuates or the optical pickup is subjected to shocks or vibration, then signal precision may end up declining in some cases.

### SUMMARY OF THE INVENTION

Preferred embodiments of the present invention provide an optical pickup and an optical disc device which easily and quickly position a light-splitting element with respect to the light-receiving unit and which also prevent a decline in signal precision caused by external disturbances.

An optical pickup according to one aspect of various preferred embodiments of the present invention includes a light-splitting element configured to split return light reflected by a recording surface of an optical disc and to scatter signal light used in signal processing and position-adjustment light that is not used in signal processing in respectively different directions other than a direction of an optical axis of zeroth-order light; and a light-receiving unit configured to receive each of the signal light and position-adjustment light generated by the light-splitting element, wherein an adjustment-light light-receiving unit configured to detect the position-adjustment light is provided on the light-receiving surface of the light-receiving unit, the adjustment-light light-receiving unit includes quartered light-receiving portions configured by equal quartering so as to be arranged in two-dimensions, and a position of the light-splitting element is adjusted based on the position-adjustment light received by each of the quartered light-receiving portions.

With the optical pickup according to one aspect of various preferred embodiments of the present invention, it is possible to detect shifts in the direction of the optical axis between the light-splitting element and the light-receiving unit and in the direction of rotation around the optical axis as a result of the position-adjustment light being received on the quartered light-receiving portions.

By doing so, it is possible for the relative distance and relative angle of the light-splitting element and the light-receiving unit to be accurately performed.

In the optical pickup according to one aspect of various preferred embodiments of the present invention described above, it is preferable that the signal light includes a first signal light which includes interference light caused by a track groove of an optical disc and a second signal light which does not include interference light caused by the track groove of the optical disc, and that the light-splitting element be configured such that the focal position of the position-adjustment light on the light-receiving surface is arranged between the focal position of the first signal light and the focal position of the second signal light in the circumferential direction that is centered on the focal position of the zeroth-order light. If such a configuration is adopted, the configuration of the light-receiving unit can be a configuration that disposes a light-receiving element that receives the position-adjustment light between a light-receiving element that receives the first signal light and a light-receiving element that receives the second signal light, so it is possible to significantly reduce or prevent increases in the size of the light-receiving unit.

In the optical pickup according to one aspect of various preferred embodiments of the present invention described above, it is preferable that the adjustment-light light-receiving unit be configured so as to be divided into the quartered light-receiving portions by a first dividing line that extends in the circumferential direction centered on the focal position of the zeroth-order light and a second dividing line that extends in the radial direction centered on the focal position of the zeroth-order light. Having such a configuration makes it possible to accurately detect fluctuations in the relative distance and fluctuations in the relative angle of the light-splitting element and the light-receiving unit, thus facilitating the positioning of the light-splitting element with respect to the light-receiving unit.

In the optical pickup according to one aspect of various preferred embodiments of the present invention described above, it is preferable that the quartered light-receiving portions each be able to quantize and output the surface area of the irradiated light, and that the light-splitting element be configured such that its position is adjusted based on a Z balance value which represents the shift in the distance between the light-splitting element and the light-receiving unit and which is calculated based on the surface areas of irradiated light that are respectively output by the quartered light-receiving portions and a θ balance value which represents the shift in the direction of rotation centered on the optical axis of the zeroth-order light and which is calculated based on the surface areas of irradiated light that are respectively output by the quartered light-receiving portions. By adopting such a configuration, the relative positions of the light-splitting element and the light-receiving unit are expressed as numerical values, so the positions of the light-splitting element and the light-receiving unit are adjusted accurately.

In the optical pickup according to one aspect of various preferred embodiments of the present invention described above, it is preferable that an adjustment target value be determined for the θ balance value according to the Z balance value, and that the light-splitting element be configured so as to adjust its position such that the θ balance value becomes the adjustment target value. If such a configuration is adopted, even in cases where the mounting positions of the light-receiving unit and the light-splitting element are determined in advance and there are variations in the distance between the light-receiving unit and the light-splitting element in the direction of the optical axis, control signals are received accurately by adjusting the angle of the light-splitting element relative to the light-receiving unit. In addition, because adjustment of the angle of the light-splitting element is accomplished numerically, the angle of the light-splitting element is adjusted easily and accurately.

In the optical pickup according to one aspect of various preferred embodiments of the present invention described above, it is preferable that the position of the light-splitting element be adjusted such that the Z balance value becomes 0 and the θ balance value becomes 0 by moving it in the direction of the optical axis of the zeroth-order light and also making it rotate centered on the optical axis of the zeroth-order light. Having such a configuration makes it possible to position the light-splitting element and the light-receiving unit with a high degree of precision.

In the optical pickup according to one aspect of various preferred embodiments of the present invention described above, it is preferable that the light-splitting element include a plurality of diffraction gratings that split the signal light and the position-adjustment light and scatter in directions respectively different from the optical axis of the zeroth-order light, and that the diffraction grating for the position-adjustment light be configured so as to be arranged in an area of the light-splitting element through which the center portion of the return light from the optical disc passes.

Various preferred embodiments of the present invention make it possible to provide an optical pickup and an optical disc device in which the light-splitting element is mounted easily and quickly with respect to the light receiving unit and which also significantly decreases or prevents the reduction in signal precision caused by external disturbances such as damage and dirt on an optical disc.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a schematic diagram showing the overall configuration of one example of the optical disc device according to a preferred embodiment of the present invention.

FIG. 2 is a schematic perspective view of one example of the optical pickup according to a preferred embodiment of the present invention.

FIG. 3 is a schematic diagram of one example of the optical pickup provided in the optical disc device shown in FIG. 1.

FIG. 4 is a diagram showing one example of the light-splitting element used in the optical pickup shown in FIG. 2.

FIG. 5 is a diagram showing examples of the diffraction gratings in the diffraction areas of the light-splitting element shown in FIG. 4.

FIG. 6 is a diagram showing an arranged state of the light-receiving elements of the light-receiving unit used in the optical pickup according to a preferred embodiment of the present invention.

FIG. 7 is a perspective view showing the light-splitting element and the light-receiving unit of the optical pickup according to a preferred embodiment of the present invention.

FIG. 8 is a diagram showing the light-receiving elements used for position adjustment and the position-adjustment light shown in FIG. 6.

FIG. 9 is a schematic diagram of the light-receiving unit of another example of the optical pickup according to a preferred embodiment of the present invention.

FIG. 10 is a diagram showing the relationship between the best θ value and the Z balance value of the optical pickup according to a preferred embodiment of the present invention.

### DETAILED DESCRIPTION OF THE PREFERRED EMBODIMENTS

Preferred embodiments of the present invention will be described below with reference to drawings.

### First Preferred Embodiment

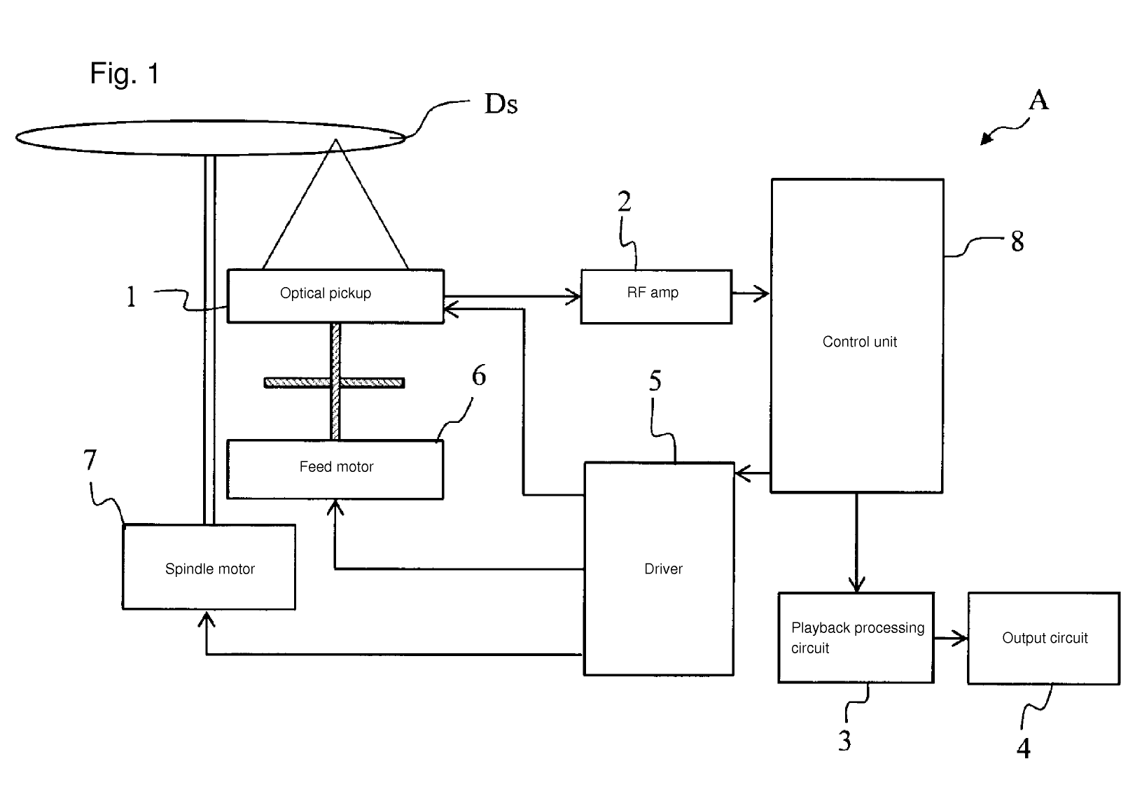

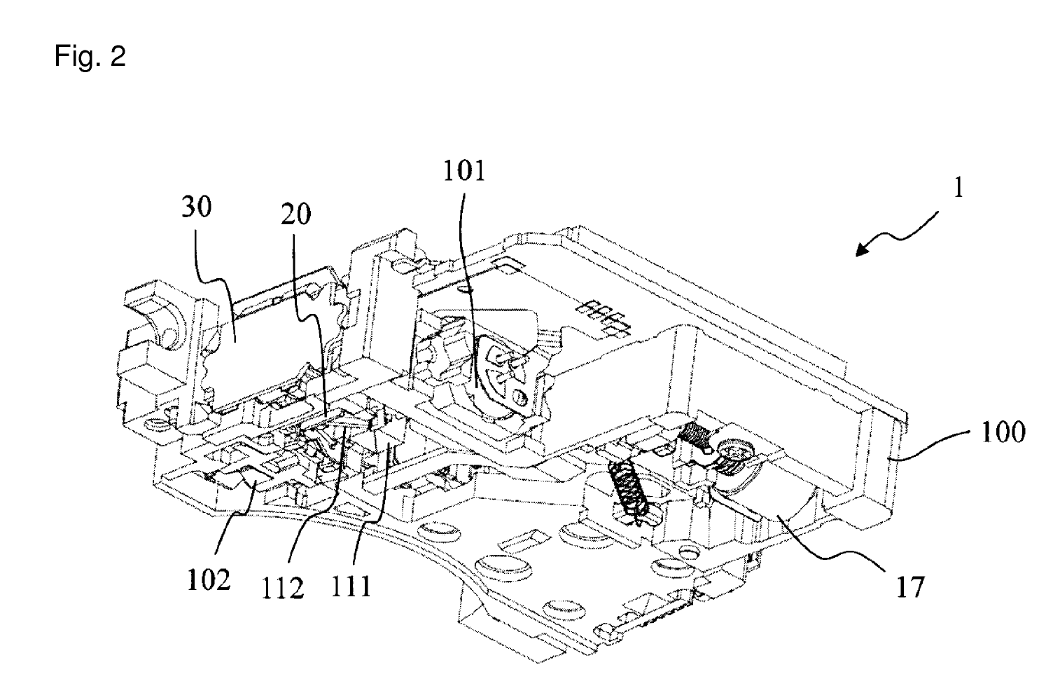

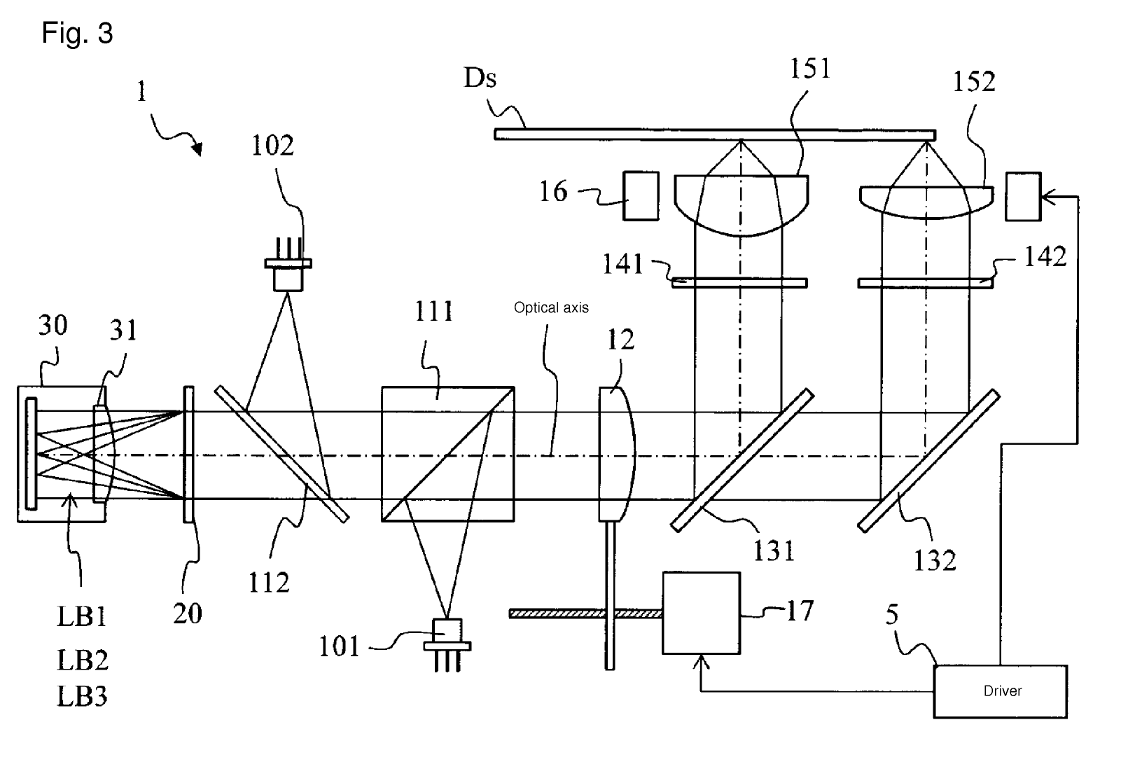

FIG. 1 is a schematic diagram showing the overall configuration of one example of the optical disc device according to a preferred embodiment of the present invention, FIG. 2 is a schematic perspective view of the optical pickup according to a preferred embodiment of the present invention, and FIG. 3 is a schematic diagram of one example of the optical pickup provided in the optical disc device shown in FIG. 1. The optical disc device A according to a preferred embodiment of the present invention preferably has a configuration in which Blu-ray discs (BDs, registered trademark), DVDs, and CDs can be played back as optical discs Ds on which information is recorded. In concrete terms, the optical disc device A is equipped with an optical pickup 1, an RF amp 2, a playback processing circuit 3, an output circuit 4, a driver 5, a feed motor 6, a spindle motor 7, and a control unit 8.

The optical pickup 1 is a device for reading various types of information (such as audio information and video information) recorded on an optical disc Ds by irradiating the optical disc Ds with laser light and detecting the light reflected by the optical disc Ds (return light). The optical pickup 1 generates the detected return light as an electrical signal and transfers this signal to the RF amp 2 as an information signal based on the various types of information. The details of the optical pickup 1 will be described later.

The RF amp 2 is configured to amplify information signals read by the optical pickup 1. The information signal amplified by the RF amp 2 is sent to the control unit 8. The playback processing circuit 3 is a circuit that acquires the information signal amplified by the RF amp 2 through the control unit 8 and runs processing to play this information signal (for example, image processing, or the like). The output circuit 4 is a circuit configured to output video and/or audio recorded on the optical disc Ds to a monitor and/or a speaker (neither of which is shown). The output circuit 4 is configured to run D/A conversion processing on information signals processed by the playback processing circuit 3. The devices to which it outputs include devices that are able to receive digital signals, and in cases where it outputs to such devices, D/A conversion processing may be omitted.

The driver 5 controls the drive of the feed motor 6 and the spindle motor 7 based on instructions from the control unit 8. Furthermore, the driver 5 also controls drive of a lens actuator 16 and a beam expander motor 17 (described below; see FIG. 3 for both) which are provided in the optical pickup 1 based on instructions from the control unit 8. The feed motor 6 is configured to make the optical pickup 1 move in the radial direction of the optical disc Ds. The spindle motor 7 is a motor to make the optical disc Ds rotate. Note that the optical disc Ds is made to rotate in a state in which it is placed on a turntable that is not shown, and the spindle motor 7 makes the optical disc Ds rotate by making the turntable rotate.

The control unit 8 generates a playback signal, a focus error (FE) signal, and a tracking error (TE) signal based on the information signals that are output from a light-receiving unit 30 (described below; see FIG. 3) which is provided in the optical pickup 1. Moreover, the control unit 8 controls the focus servo based on the FE signal and controls the tracking servo based on the TE signal when the optical disc Ds is playing.

Next, the optical pickup according to a preferred embodiment of the present invention will be described with reference to drawings. As shown in FIG. 3, the optical pickup 1 preferably includes a first light source 101, a second light source 102, a polarization beam splitter 111, a half-mirror 112, a collimating lens 12, a first rising mirror 131, a second rising mirror 132, quarter-wave plates 141 and 142, a first objective lens 151, and a second objective lens 152. In addition, the optical pickup 1 is also equipped with the lens actuator 16 that moves the objective lenses 151 and 152 and the beam expander motor 17 that moves the collimating lens 12. The optical pickup 1 also preferably includes a light-splitting element 20 and the light-receiving unit 30. These various members are installed on a chassis 100 (see FIG. 2).

Among the optical elements described above, optical elements other than the first objective lens 151 and the second objective lens 152 are disposed in the recessed portion of the chassis 100. A flat plate-shaped cover made of metal (not shown) is then affixed so as to cover the opening thereof. By attaching the cover, the optical elements are disposed in a space that is sealed by the chassis 100 and the cover, which therefore inhibits foreign matters such as dust and dirt getting into or onto the optical elements. Furthermore, the cover also functions as a heatsink that assists in heat dissipation.

Moreover, the first objective lens 151 and the second objective lens 152 are provided on the lens actuator 16. The lens actuator 16 is a drive device that moves the first objective lens 151 or the second objective lens 152 in the radial direction of the optical disc or in the approaching/separating direction.

The optical elements of the optical pickup 1 will now be described in detail. The first light source 101 is a laser diode that emits blue laser light (wavelength approximately 405 nm) for recording/playback of BDs. The laser light emitted from the first light source 101 is incident on the polarization beam splitter 111. The polarization beam splitter 111 is an optical element for the laser light emitted from the first light source 101, i.e., blue laser light, being an optical element which is such that when blue laser light is incident on the optical element, it reflects or passes through the light depending on the polarization direction of this incident light. Note that the polarization beam splitter 111 will be described in terms of an optical element that reflects P-polarized light and passes S-polarized light. The laser light emitted from the first light source 101 is P-polarized laser light; it is reflected at the reflection surface of the polarization beam splitter 111, and its light path bends.

Meanwhile, the second light source 102 is a laser diode that is configured to selectively emit either red laser light for DVD recording/playback (wavelength approximately 650 nm) or infrared laser light for CD recording/playback (wavelength approximately 780 nm). The red laser light or infrared laser light emitted from the second light source 102 is incident on the half-mirror 112. A portion of the red laser light or infrared laser light that is incident on the half-mirror 112 passes through the half-mirror 112 while the remaining amount of light is reflected and incident on the polarization beam splitter 111.

As was described above, because the polarization beam splitter 111 is an optical element for blue laser light, the entire amount (or substantially the entire amount) of incident red laser light and infrared laser light is transmitted. Note that when “laser light” is mentioned in the following description without any particular distinction, it is assumed to refer to all three types, i.e., blue laser light, red laser light, and infrared laser light. When the wording simply as “laser light” is used, it is assumed that this laser light is converted by an optical element, reflected, or passed through an optical element regardless of wavelength of the laser light.

The laser light that exits the polarization beam splitter 111 is incident on the collimating lens 12. The collimating lens 12 is a lens configured to correct aberration in diverging light to obtain parallel light. Note that, in order to accurately create parallel light from light of the differing wavelengths of blue laser light, red laser light, and infrared laser light, the collimating lens 12 is configured so as to be movable in the direction of the optical axis. Laser light that passes through the collimating lens 12 is incident on the first rising mirror 131.

The first rising mirror 131 is a dichroic mirror that reflects light within a specified wavelength band and passes light in other wavelength bands. The first rising mirror 131 has the characteristic of reflecting blue laser light and transmitting red laser light and infrared laser light. The first rising mirror 131 reflects blue laser light in the direction (rising direction) of the optical disc (BD), and the blue laser light reflected by the first rising mirror 131 is incident on the quarter-wave plate 141.

The quarter-wave plate 141 is an optical element that shifts the phase of incident light by one quarter of its wavelength. The quarter-wave plate 141 is an optical element that converts linearly polarized light to circularly polarized light and circularly polarized light to linearly polarized light. The blue laser light reflected by the first rising mirror 131 is linearly polarized light; after it passes through the quarter-wave plate 141, it is converted to circularly polarized light and incident on the first objective lens 151.

The first objective lens 151 is a condensing lens that concentrates blue laser light and directs it onto the recording layer of the BD as a laser spot. The blue laser light reflected at the recording layer of the optical disc (BD) (return light) returns to the original parallel light by passing through the first objective lens 151 and is converted to linearly polarized light by passing through the quarter-wave plate 141. Note that the return light that has passed through the quarter-wave plate 141 is linearly polarized light that is rotated in the orthogonal direction relative to the original light. The return light that has passed through the quarter-wave plate 141 is reflected by the first rising mirror 131.

Meanwhile, in cases where the laser light that exits from the collimating lens 12 is red laser light or infrared laser light, it is outside the wavelength bands that are reflected by the first rising mirror 131, so the entire amount or substantially the entire amount of the light passes through the first rising mirror 131. The red laser light or infrared laser light that has passed through the first rising mirror 131 is incident on the second rising mirror 132. The second rising mirror 132 is a total reflection-type mirror; red laser light or infrared laser light that is reflected by the second rising mirror 132 in the direction (rising direction) of the optical disc (DVD or CD) passes through the quarter-wave plate 142, is converted to circularly polarized light, and is incident on the second objective lens 152. Note that the quarter-wave plate 142 has a similar effect to the quarter-wave plate 141 and converts linearly polarized light to circularly polarized light and circularly polarized light to linearly polarized light. While the details will be omitted, the light from the collimating lens and the return light are linearly polarized light that are orthogonal to each other even at the quarter-wave plate 142.

The second objective lens 152 is a condensing lens that concentrates incident red laser light or infrared laser light and directs it onto the respectively corresponding recording layer of the optical disc (DVD or CD) as a laser spot. The red laser light or infrared laser light reflected at the DVD or CD (return light) returns to the original parallel light by passing through the second objective lens 152, is reflected by the second rising mirror 132, and is incident on the first rising mirror 131. As was described above, the first rising mirror 131 does not reflect light other than blue laser light but instead passes it through, so red laser light and infrared laser light pass through the first rising mirror 131.

The blue laser light that has been reflected by the first rising mirror 131 and the red laser light or infrared laser light that has passed through the first rising mirror 131 travel the same (or substantially the same) light path as the outward path and are incident on the collimating lens 12. The laser light that is incident on the collimating lens 12 is converted from parallel light to convergent light and incident on the polarization beam splitter 111.

As was described above, the quarter-wave plates 141 and 142 convert linearly polarized light to circularly polarized light and circularly polarized light to linearly polarized light; laser light that is incident from the light source side and return light that is reflected by the optical disc have polarization directions that are orthogonal to each other. The return light of blue laser light is linearly polarized light that is orthogonal to the light from the light source. The polarization beam splitter 111 reflects or passes light based on its polarization direction; because it reflects light from the first light source 101, return light is passed through the polarization beam splitter 111. In addition, the polarization beam splitter 111 is an optical element for blue laser light, so red laser light and infrared laser light pass through the polarization beam splitter 111.

The laser light that has passed through the polarization beam splitter 111 is incident on the half-mirror 112. A portion of the laser light is reflected by the half-mirror 112, and the remainder passes through.

The return light reflected by the recording surface of the optical disc Ds passes through the half-mirror 112 and is incident on the light-splitting element 20. The light-splitting element 20 is a hologram element on which is provided a plurality of diffraction patterns (diffraction gratings); it splits the return light from the optical disc Ds while also scattering the split light into different directions. The light-splitting element 20 generates signal light used for the signal processing of the optical disc Ds (first signal light LB1 and second signal light LB2) and position-adjustment light LB3 that is not used in signal processing. A tracking error signal is generated from the first signal light LB1 and the second signal light LB2. The details of the light-splitting element 20 will be described below.

The light-receiving unit 30 preferably includes a cylindrical lens 31 and light-receiving elements (to be described below) that receive the light scattered by the light-splitting element 20. The cylindrical lens 31 is a lens that is configured to focus light in one direction only; it is a sensor lens configured to generate the focus error signal. The respective light-receiving elements of the light-receiving unit are configured so as to be equipped with light-detecting elements such as photodiodes; when a light-receiving element detects signal light, it converts the signal light into an electrical signal. The converted electrical signal is sent to the RF amp 2 (see FIG. 1). The details of the light-receiving elements of the light-receiving unit 30 will be described later.

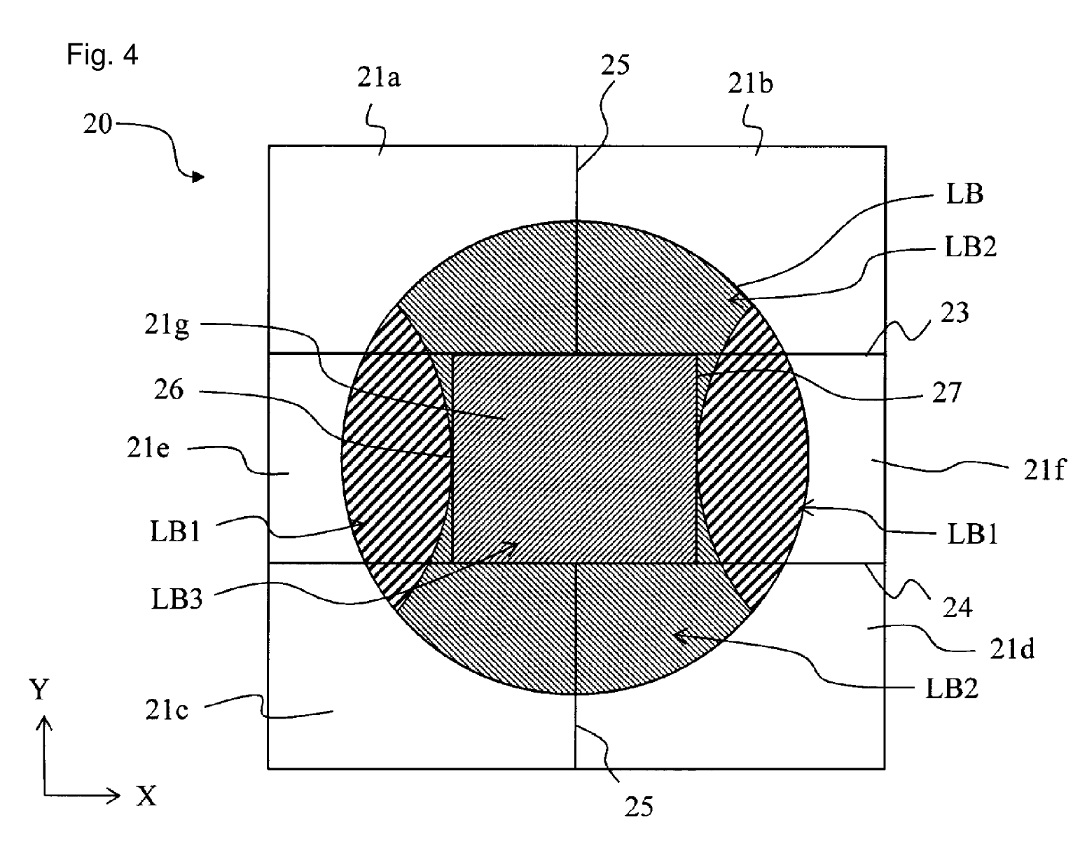

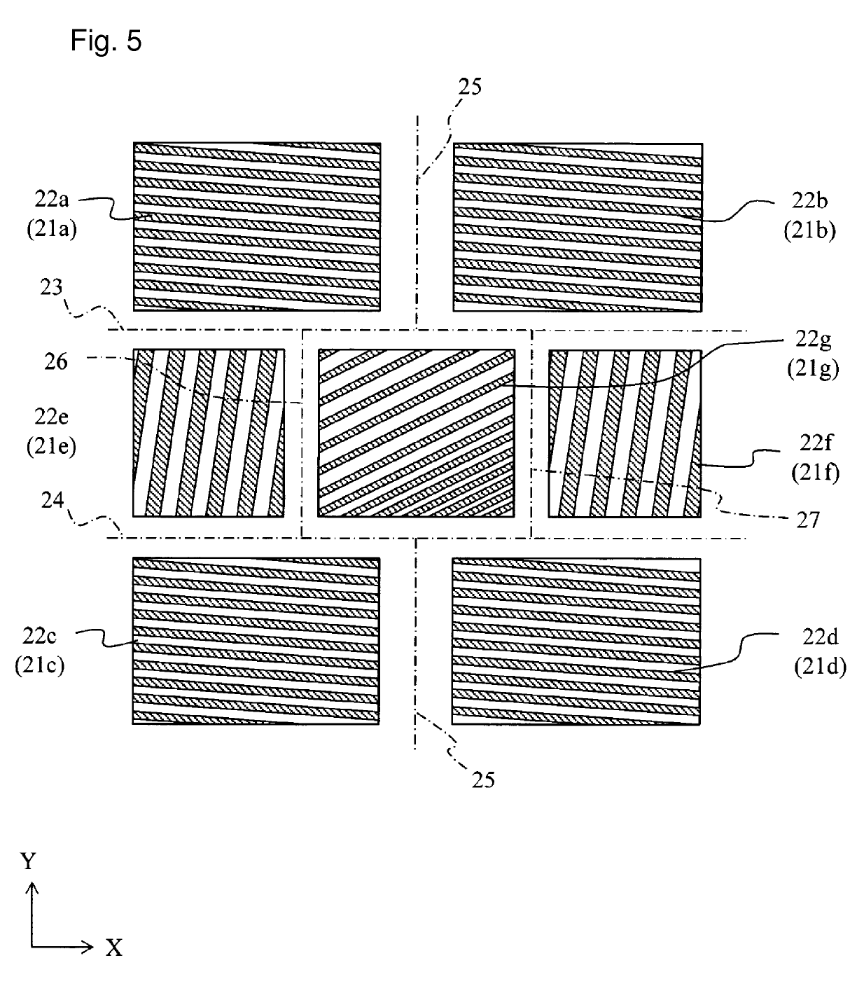

Next, the details of the light-splitting element will be described with reference to drawings. FIG. 4 is a diagram showing one example of the light-splitting element used in the optical pickup according to a preferred embodiment of the present invention, and FIG. 5 is a diagram showing examples of the diffraction gratings in the diffraction areas of the light-splitting element shown in FIG. 4.

As shown in FIG. 4, the light-splitting element 20 preferably splits a rectangular light-receiving surface into seven portions, for example, thus enabling there to be seven diffraction areas 21a through 21g. Note that, in the light-splitting element 20, of the orthogonal X axis and Y axis shown in FIG. 4, the X-axis direction is the tracking direction, while the Y-axis direction is the tangential direction of the tracks. Furthermore, the light-splitting element 20 is disposed such that the light beam LB of return light is received in the center of the light-receiving surface as shown in FIG. 4. The two end portions in the X-axis direction of the light beam LB of return light shown in FIG. 4 include interference caused by the track groove of the optical disc Ds, while the two end portions in the Y-axis direction do not include interference caused by the track groove.

As shown in FIG. 4, the light-splitting element 20 is preferably divided into three equal portions in the Y direction by two dividing lines 23 and 24 that extend in the X direction. Moreover, among the three split regions, the two regions at both ends in the Y direction are each divided into two equal portions in the X direction by a dividing line 25 that extends in the Y direction, for example. As a result, diffraction areas 21a, 21b, 21c, and 21d are provided at the two ends in the track tangential direction (Y direction) by dividing each of these two ends into two portions in the tracking direction (X direction).

The region in the center portion in the Y direction (between the dividing lines 23 and 24) is divided into three portions in the X direction by two dividing lines 26 and 27 that are provided on both sides sandwiching a center portion in the X direction and that extend in the Y direction. By doing so, the center region in the track tangential direction (Y direction) defines diffraction areas 21e and 21f on the two ends in the tracking direction (X direction) and a diffraction area 21g in the center area in the X direction.

As a result of the diffraction areas 21a through 21g being configured in this manner, first signal light LB1 obtained by the split at the two end portions in the tracking direction (X direction) is generated from the light beam LB of laser light that passes through the light-splitting element 20. Moreover, second signal light LB2 obtained by the split at the two end portions in the track tangential direction (Y direction) of the pass-through region of the light beam LB is generated. In addition, position-adjustment light LB3 obtained by the split at the center portion of the pass-through region of the light beam LB is generated.

Here, the first signal light LB1 is the light that splits the portion of the light beam LB of the return light that includes interference light (±1st order light) caused by the track groove of the optical disc Ds, and the second signal light LB2 is the light that splits the portion that does not include interference light (±1st order light) caused by the track groove. Furthermore, the position-adjustment light LB3 is the split light that does not use the electrical signal obtained by converting light received by the light-receiving unit 30 as a tracking error signal or a playback signal of the optical disc Ds (it is not used in optical disc signal processing). Moreover, the position-adjustment light LB3 is light that is used only for the position adjustment of the light-splitting element 20 and the light-receiving unit 30.

As shown in FIG. 5, diffraction patterns 22a through 22g of respectively differing shapes are provided in the seven diffraction areas 21a through 21g (see FIG. 5). Note that the diffraction patterns 22a through 22g shown in FIG. 5 are meant to show that each of the diffraction areas 21a through 21g has a different pattern; they may differ from actual diffraction patterns. The first signal light LB1, the second signal light LB2, and the position-adjustment light LB3 are each diffracted (scattered) from the light beam LB in different directions and concentrated on the light-receiving elements of the light-receiving unit 30 by the diffraction patterns 22a through 22g shown in FIG. 5.

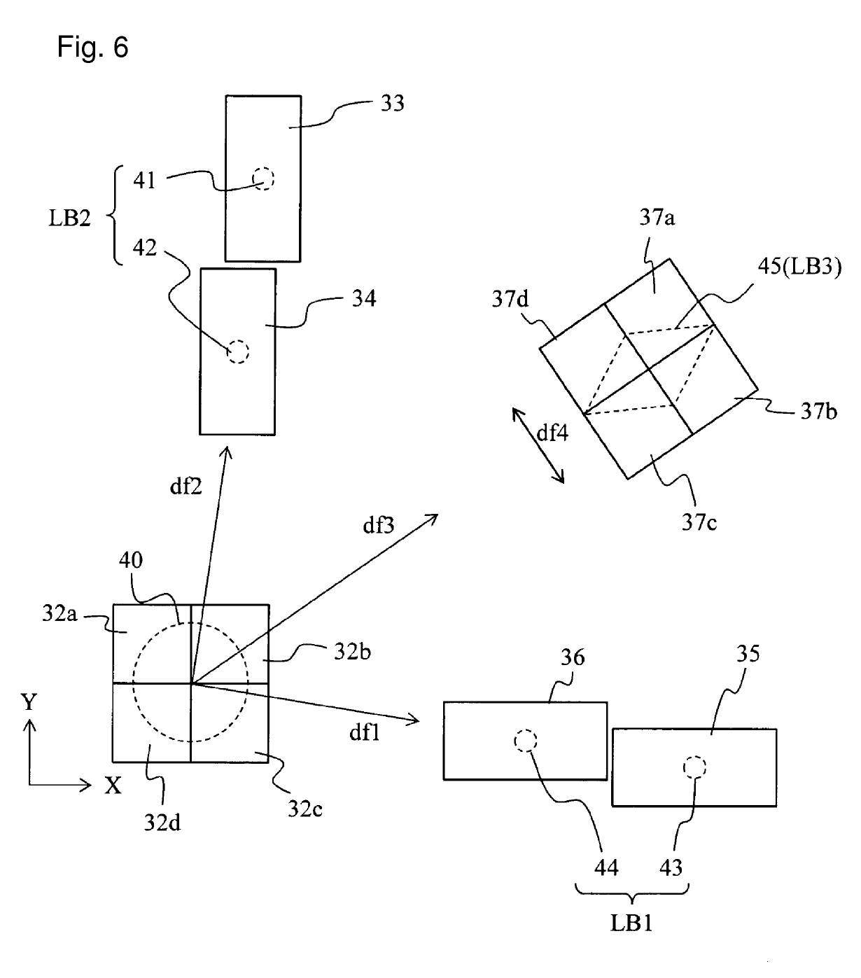

Next, the light-receiving element 30 will be described with reference to drawings. FIG. 6 is a diagram showing an arranged state of the light-receiving elements of the light-receiving unit used in the optical pickup according to a preferred embodiment of the present invention. Note that photodiodes are used for the light-receiving elements, and these are elements which output electrical signals according to the amount of irradiated light. In addition, it is assumed that the light that is directed onto the light-receiving surface of the light-receiving unit 30 is uniform light, and that the light-receiving elements determine the amount of output by the size of the irradiated surface area.

As shown in FIG. 6, the light-receiving unit 30 is equipped with four main light-receiving elements 32a, 32b, 32c, and 32d that are configured by evenly quartering in the direction along the X axis (X direction) and in the direction along the Y axis (Y direction). The main light-receiving elements 32a, 32b, 32c, and 32d are light-receiving elements that receive light after splitting the zeroth-order diffracted light (main beam) of the light beam LB that has passed through the light-splitting element 20 into four.

Furthermore, the light-receiving unit 30 preferably includes light-receiving elements 33 and 34 arranged at positions that extend substantially in the Y direction (in a direction df2) from the center of the main light-receiving elements 32a, 32b, 32c, and 32d. As shown in FIG. 6, the light-receiving element 33 is provided at a position farther away from the center of the main light-receiving elements 32a, 32b, 32c, and 32d than the light-receiving element 34. Moreover, the light-receiving unit 30 similarly preferably includes light-receiving elements 35 and 36 arranged at positions that extend substantially in the X direction (in a direction df1). The light-receiving elements 35 and 36 have a rectangular or substantially rectangular shape that extends in the direction df1. In addition, the light-receiving element 35 is provided at a position farther away from the center of the main light-receiving elements 32a, 32b, 32c, and 32d than the light-receiving element 36.

Furthermore, at a position separated by a certain distance in a direction df3 that divides the angle defined by the direction df1 and the direction df2 into two equal or substantially equal portions, the light-receiving unit 30 preferably includes light-receiving elements 37a, 37b, 37c, and 37d that are configured by equal quartering in the direction df3 and in a direction df4 that is perpendicular or substantially perpendicular to the direction df3. The light-receiving elements 37a through 37d define the adjustment-light light-receiving unit on which the position-adjustment light LB3 is incident, and each of the light-receiving elements 37a through 37d defines each of the quartered light-receiving portions.

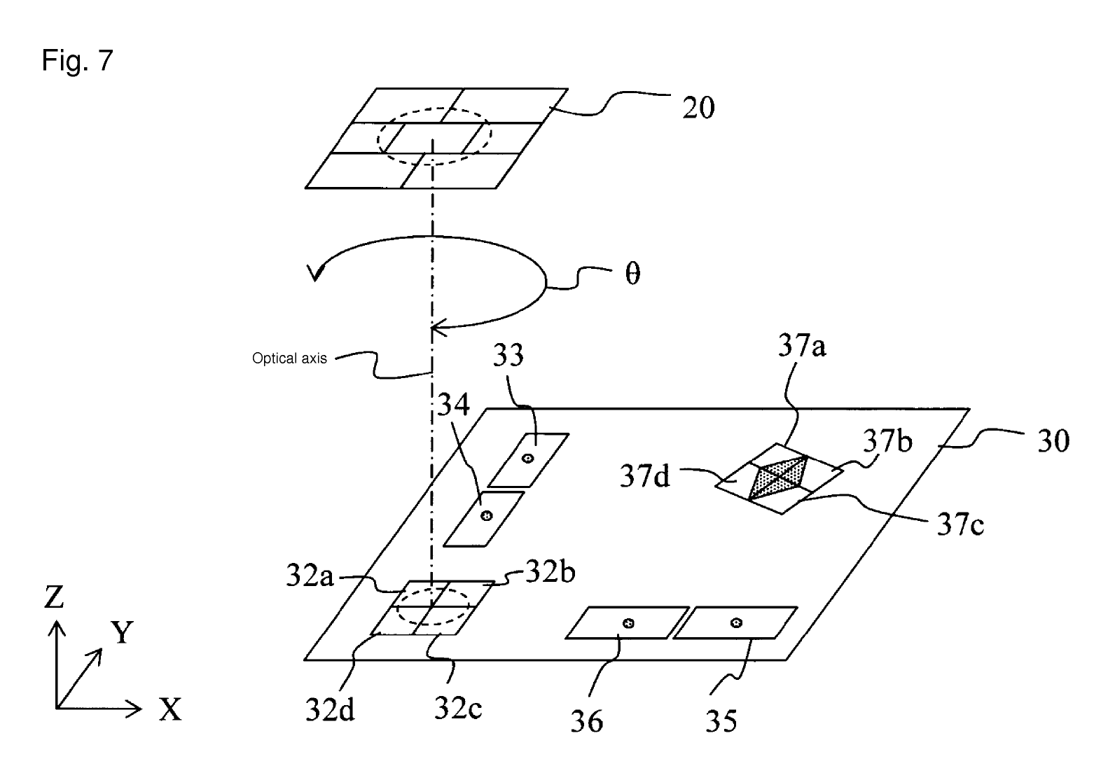

Next, the splitting of the return light by the light-splitting element 20 will be described with reference to drawings. FIG. 7 is a perspective view showing the light-splitting element and the light-receiving unit of the optical pickup according to a preferred embodiment of the present invention. In FIG. 7, for ease of explanation, the optical axis of the return light is shown as extending in the vertical direction.

As shown in FIG. 7, the axis parallel to the optical axis of the return light is set as the Z axis, and the direction along the optical axis is set as the Z-axis direction. Moreover, the circumferential direction centered on the optical axis is set as the θ direction. In the optical pickup 1, the light-receiving unit 30 and the light-splitting element 20 are disposed such that the light-receiving surface of the light-receiving unit 30 and the surface that passes light of the light-splitting element 20 are parallel or substantially parallel in a state in which they are separated by a certain distance in the Z direction. In addition, the arrangement is such that the optical axis of the zeroth-order diffracted light out of the return light that passes through the light-splitting element 20 overlaps the center of the main light-receiving elements 32a, 32b, 32c, and 32d. Furthermore, the arrangement is such that the X axis and Y axis of the light-receiving unit 30 are respectively parallel or substantially parallel to the X axis and Y axis of the light-splitting element 20.

Moreover, by adjusting the distance in the Z direction between the light-splitting element 20 and the light-receiving unit 30 and the angle in the θ direction, the light signals generated by the light-splitting element 20 are directed accurately onto the light-receiving elements. Here, each of the light signals generated by the light-splitting element 20 will be described. Note that a description will be given here of a case in which the light-splitting element 20 and the light-receiving unit 30 are positioned at an accurate distance and angle.

The zeroth-order light that is not affected by the diffraction areas out of the light beam LB of the return light that passes through the light-splitting element 20 is directed onto the light-receiving unit 30 so as to have the same optical axis as the return light that is guided to the light-splitting element 20, and a zeroth-order light spot 40 is provided on the light-receiving surface of the light-receiving unit 30. In addition, the main light-receiving elements 32a, 32b, 32c, and 32d are arranged at the focal position of the zeroth-order light spot 40 on the light-receiving surface of the light-receiving unit 30.

The diffraction areas 21a and 21c (see FIG. 4) on one side of the tracking direction (X direction) of the light-splitting element 20 generate second pass-through light LB2 by passing the light beam LB of the return light. The diffraction patterns of the diffraction areas 21a and 21c are configured so as to diffract the generated second pass-through light LB2 substantially toward the Y direction (direction df2) and so as to define a circular focus spot 41 on the light-receiving surface of the light-receiving unit 30. Furthermore, the light-receiving element 33 is arranged at the focal position of the focus spot 41 on the light-receiving surface of the light-receiving unit 30.

The diffraction areas 21b and 21d (see FIG. 4) on the other side of the tracking direction (X direction) of the light-splitting element 20 also generate second pass-through light LB2 by passing the light beam LB of the return light. The diffraction patterns of the diffraction areas 21b and 21d are configured so as to diffract the generated second pass-through light LB2 toward or substantially toward the Y direction (direction df2) and so as to define a circular focus spot 42 on the light-receiving surface of the light-receiving unit 30. Moreover, the light-receiving element 34 is arranged at the focal position of the focus spot 42 on the light-receiving surface of the light-receiving unit 30 (see FIG. 6).

In addition, the diffraction area 21e (see FIG. 4) on one side of the tracking direction (X direction) generates first pass-through light LB1 by passing the light beam LB of the return light. The diffraction pattern of the diffraction area 21e is configured so as to diffract the generated first pass-through light LB1 toward or substantially toward the X direction (direction df1) and so as to define a circular focus spot 43 on the light-receiving surface of the light-receiving unit 30 (see FIG. 6). Furthermore, the light-receiving element 35 is arranged at the focal position of the focus spot 43 on the light-receiving surface of the light-receiving unit 30 (see FIG. 6).

Moreover, the diffraction area 21f (see FIG. 4) on the other side of the tracking direction (X direction) generates first pass-through light LB1 by passing the light beam LB of the return light. The diffraction pattern of the diffraction area 21f is configured so as to diffract the generated first pass-through light LB1 toward or substantially toward the X direction (direction df1) and so as to define a circular focus spot 44 on the light-receiving surface of the light-receiving unit 30. In addition, the light-receiving element 36 is arranged at the focal position of the focus spot 44 on the light-receiving surface of the light-receiving unit 30 (see FIG. 6).

The second signal light LB2 split into two portions toward the track tangential direction (Y direction) in this manner is received by the light-receiving element 33 and the light-receiving element 34, and the first signal light LB1 split into two portions toward the tracking direction (X direction) is received by the light-receiving element 35 and the light-receiving element 36. The respective light-receiving elements through 36 generate electrical signals from the received signal light, and the generated electrical signals are amplified by the RF amp 2 and then sent to the control unit 8. The control unit 8 generates a TE (tracking error) signal based on the electrical signals sent to it and operates the tracking action based on the TE signal (tracking servo control).

Furthermore, the diffraction area 21g (see FIG. 4) in the center portion generates position-adjustment light LB3 by passing the light beam LB of the return light. The diffraction pattern of the diffraction area 21g is configured so as to diffract the generated position-adjustment light LB3 toward the direction (direction df3) of the line that divides, into two equal portions, the angle defined by the diffraction direction df1 of the first signal light Lb1 and the diffraction direction df2 of the second signal light Lb2 being centered on the zeroth-order light spot 40. Moreover, the position-adjustment light LB3 defines a focus spot 45 in the shape of a parallelogram on the light-receiving surface of the light-receiving unit 30. The light-receiving elements 37a through 37d are arranged at the focal position of the focus spot 45 on the light-receiving surface of the light-receiving unit 30 (see FIG. 6).

The light-receiving elements 37a through 37d each preferably have a square or substantially square shape and are arranged adjacently in a 2×2 matrix. The light-receiving elements 37a through 37d are arranged such that the center of the focus spot 45 overlaps the point where the vertices of the light-receiving elements 37a through 37d come together (their center).

As was shown above, it can be seen that the light-receiving elements 32a through 32d, 33, 34, 35, 36, and 37a through 37d of the light-receiving unit 30 and the shapes (configurations) of the respective diffraction areas 21a through 21g of the light-splitting element 20 are linked to each other. As long as the configuration is such that the focus spots are formed accurately on the respective light-receiving elements, the present invention is not limited to the shapes of the light-splitting element 20 and light-receiving unit 30 described above.

In the optical pickup 1, the light-splitting element and the light-receiving unit 30 are both mounted on the chassis 100 and secured in place with adhesive or the like. As was described above, if the distance between the light-splitting element 20 and the light-receiving unit 30 and the angle of rotation centered on the optical axis shift, then some or all of the respective focus spots are not formed on the specified light-receiving elements, thus making it difficult to acquire accurate signals with the light-receiving elements. In addition, in cases where the angle of rotation shifts and a focus spot is formed on an end portion of the corresponding light-receiving element, if the focus is off due to damage, warping, or the like of the optical disc, the focus spot may end up moving off the light-receiving element, which can cause lowering of the TE signal precision.

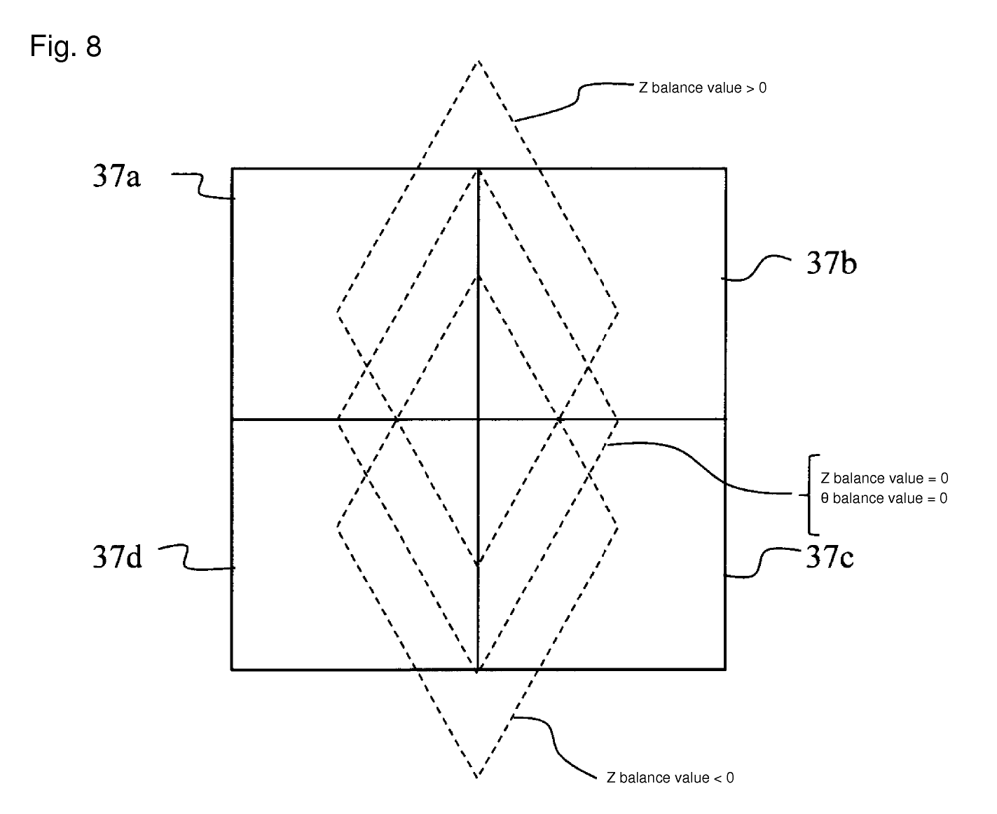

In light of this, the optical pickup 1 according to a preferred embodiment of the present invention is configured so as to allow the distance in the Z direction between the light-splitting element 20 and the light-receiving unit 30 and the rotation in the θ direction to be adjusted by utilizing the position-adjustment light LB3. The position adjustment of the light-splitting element 20 and the light-receiving unit 30 according to a preferred embodiment of the present invention will be described with reference to drawings. FIG. 8 is a diagram showing the light-receiving elements used for position adjustment and the position-adjustment light shown in FIG. 6.

As shown in FIG. 8, the position-adjustment light LB3 diffracted by the diffraction area 21g of the light-splitting element 20 generates a focus spot 45 on the light-receiving elements 37a through 37d used for position adjustment. This means that light is directed onto the focus spot 45; with the focus spot 45 being irradiated, the light-receiving elements 37a through 37d used for position adjustment respectively convert the received position-adjustment light LB3 into electrical signals.

As shown in FIG. 8, the light-receiving elements used for position adjustment are preferably arranged as follows: namely, the light-receiving elements 37a and 37b are arranged in the portion farther away from the location onto which the zeroth-order light is directed, the light-receiving element 37c is provided at the position adjacent to the light-receiving element 37b in the nearer portion, and the light-receiving element 37d is arranged at the position adjacent to the light-receiving element 37a.

Furthermore, as was described above, the position-adjustment light LB3 is diffracted by the diffraction area 21g when it passes through the light-splitting element 20 and is inclined at a certain angle relative to the light-receiving elements 37a through 37d. For this reason, as the light-splitting element 20 and the light-receiving unit 30 get closer, the focus spot 45 of the position-adjustment light LB3 moves in a direction that approaches the focus spot 40 created by the zeroth-order light. Moreover, as the light-splitting element 20 and the light-receiving unit 30 get farther apart, the focus spot 45 conversely moves in a direction away from the focus spot created by the zeroth-order light. In addition, when the light-splitting element 20 and the light-receiving unit 30 rotate in the θ direction, the focus spot 45 rotates.

In the optical pickup 1, when the distance between the light-splitting element 20 and the light-receiving unit 30 (the distance in the Z direction) and their relative angle (the relative angle in the θ direction) reach a predetermined angle, a focus spot 45 is generated such that the center thereof overlaps the center of the light-receiving elements 37a through 37d.

Therefore, the Z balance value (which indicates the amount of deviation in the Z direction from the appropriate distance) and the θ balance value (which indicates the amount of deviation of the angle in the θ direction) are calculated from the electrical signals that are output from the light-receiving elements 37a through 37d. Here, if the electrical signals that are output from the light-receiving elements 37a, 37b, 37c, and 37d are designated as Sg1, Sg2, Sg3, and Sg4, then the Z balance value and the θ balance value preferably are calculated from the following equations:

Z balance value=[(Sg1+Sg2)−(Sg3+Sg4)]/(Sg1+Sg2+Sg3+Sg4)

θ balance value=[(Sg2+Sg3)−(Sg1+Sg4)]/(Sg1+Sg2+Sg3+Sg4)

Because the focus spot 45 has a parallelogram shape, when the center of the focus spot 45 overlaps the center of the light-receiving elements 37a through 37d, the shape of the focus spot 45 “cut out” by the light-receiving element 37a and the light-receiving element 37c is the same, and the shape “cut out” by the light-receiving element 37b and the light-receiving element 37d is the same. That is, the signal Sg1 and the signal Sg3 have the same value, as do the signal Sg2 and the signal Sg4. Based on the above, when the center of the focus spot 45 coincides with the center of the light-receiving elements 37a through 37d, the Z balance value and the θ balance value both equal zero.

The optical pickup 1 takes advantage of this property to perform position adjustment of the light-splitting element 20 and the light-receiving unit 30. In the assembly of the optical pickup 1, first, the light-receiving unit 30 is mounted and secured in a specified position, here, in the position which is such that the optical axis of the return light is directed onto the center of the main light-receiving elements 32a through 32d.

Then, the light-splitting element 20 is disposed between the half-mirror 11 and the light-receiving unit 30 in a state in which the same return light as when the optical pickup 1 is driven is directed toward the light-receiving unit 30. At this point, the signals Sg1 through Sg4 that are output from the light-receiving elements 37a through 37d are acquired, and the Z balance value and the θ balance value described above are calculated from the signals Sg1 through Sg4. Then, the light-splitting element 20 is moved relative to the light-receiving unit 30 to find the position where the Z balance value equals zero. Furthermore, at the position where the Z balance value equals zero, the light-splitting element 20 is rotated around the optical axis of the return light such that the θ balance value equals zero.

Thus, the Z balance value and the θ balance value are calculated using the focus spot 45 of the position-adjustment light LB3, and the distance of the light-splitting element 20 from the light-receiving unit 30 and the angle of rotation are adjusted based on these values, so the position is adjusted simply and accurately.

### Second Preferred Embodiment

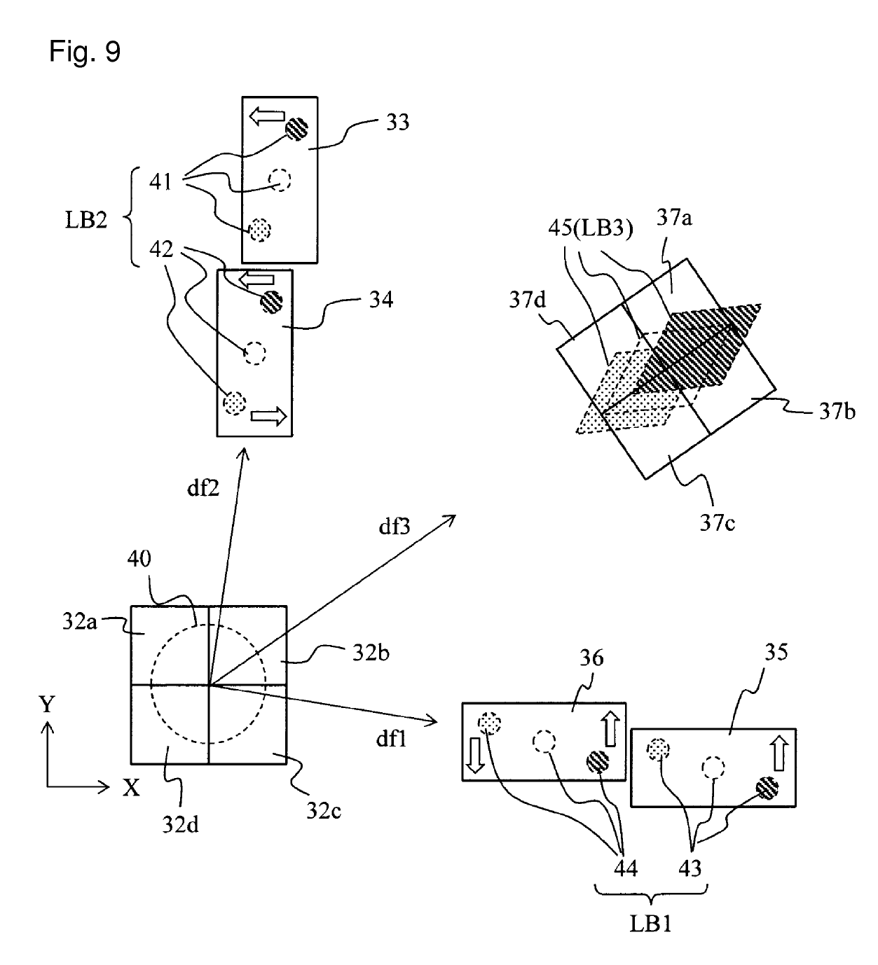

Another example of the optical pickup according to a second preferred embodiment of the present invention will be described with reference to drawings. FIG. 9 is a schematic diagram of the light-receiving unit of another example of the optical pickup according to the second preferred embodiment of the present invention. With the optical pickup 1 according to the second preferred embodiment of the present invention, a chassis 100 that determines in advance the location where the light-splitting element 20 and the light-receiving unit 30 will be mounted is often used in order to simplify manufacturing. When the light-splitting element 20 and the light-receiving unit are mounted on such a chassis 100, manufacturing errors in the chassis 100 itself or assembly error in the light-splitting element 20 and (or) the light-receiving unit 30 may occur.

FIG. 9 shows the focus spots that are formed on each light-receiving element when there is variation in the relative positions of the light-splitting element 20 and the light-receiving unit 30. The first signal light LB1, the second signal light LB2, and the position-adjustment light LB3 are diffracted light that is directed from the light-splitting element 20 toward directions different from the optical axis of the zeroth-order light. For this reason, when the distance between the light-splitting element 20 and the light-receiving surface of the light-receiving unit 30 changes, the positions of the focus spots vary.

As the distance between the light-splitting element 20 and the light-receiving surface of the light-receiving unit 30 is increased, the focus spot 45 of the position-adjustment light LB3 shifts in a direction away from the focus spot 40 of the zeroth-order light. As this happens, the Z balance value becomes larger. Moreover, the focus spots 41 and 42 of the second signal light LB2 shift in a direction away from the focus spot 40 of the zeroth-order light while also shifting in the counterclockwise direction as seen from the side of the light-splitting element 20 centered around the focus spot 40. In addition, the focus spots 43 and 44 of the first signal light LB1 similarly shift in a direction away from the focus spot 40 of the zeroth-order light while also shifting in the counterclockwise direction as seen from the side of the light-splitting element 20 centered around the focus spot 40 (see FIG. 9).

Conversely, as the distance between the light-splitting element 20 and the light-receiving surface of the light-receiving unit 30 is reduced, the focus spot 45 of the position-adjustment light LB3 shifts in a direction that approaches the focus spot 40 of the zeroth-order light. As this happens, the Z balance value becomes smaller. Furthermore, the focus spots 41 and 42 of the second signal light LB2 shift in a direction that approaches the focus spot 40 of the zeroth-order light while also shifting in the clockwise direction as seen from the side of the light-splitting element 20 centered around the focus spot 40. Moreover, the focus spots 43 and 44 of the first signal light LB1 similarly shift in a direction that approaches the focus spot 40 of the zeroth-order light while also shifting in the clockwise direction as seen from the side of the light-splitting element 20 centered around the focus spot 40 (see FIG. 9).

In the optical pickup 1, when an optical disc Ds that has abnormalities such as damage or dirt on its clear layer is replayed, the return light is affected by these abnormal portions. If return light is affected by the abnormalities, the focus spots 43 and 44 of the first signal light LB1 and the focus spots 41 and 42 of the second signal light LB2 shift in the direction of rotation centered on the optical axis of the zeroth-order light. When the focus spots shift in the direction of rotation, there is a possibility that some or all of the focus spots move off of the corresponding light-receiving elements. When the focus spots move off of the corresponding light-receiving elements, the precision of the TE signal obtained from the first signal light LB1 and second signal light LB2 detected by the light-receiving elements declines.

With the optical pickup 1, in order to prevent or significantly reduce the shift of the focus spots from the light-receiving elements due to external disturbances as described above, the light-splitting element 20 is rotated and fixed in place such that the focus spots 41, 42, 43, and 44 are respectively generated substantially in the center of the light-receiving elements 33, 34, 35, and 36 in the direction of rotation. Next, the position adjustment of the light-splitting element 20 in the direction of rotation will be described.

The amount of shift of the focus spots from the centers of the corresponding light-receiving elements is determined by the distance between the light-splitting element and the light-receiving unit 30. As was described above, when both the distance between the light-splitting element 20 and the light-receiving unit 30 and the angle between the two are appropriate, the Z balance value and the θ balance value are both zero. Then, if the Z balance value becomes less than zero, the focus spots 41, 42, 43, and 44 will shift counterclockwise as centered on the optical axis of the zeroth-order light. For this reason, when the Z balance value is less than zero, the focus spots 41, 42, 43, and 44 are returned to the center of the light-receiving elements 33, 34, 35, and 36 in the direction of rotation by rotating the light-splitting element 20 clockwise (in the direction in which the θ balance value becomes larger).

In addition, if the Z balance value becomes greater than zero, the focus spots 41, 42, 43, and 44 will shift clockwise as centered on the optical axis of the zeroth-order light. For this reason, when the Z balance value is greater than zero, the focus spots 41, 42, 43, and 44 are returned to the center of the light-receiving elements 33, 34, 35, and 36 in the direction of rotation by rotating the light-splitting element 20 counterclockwise (in the direction in which the e balance value becomes smaller). If the θ balance value when the light-splitting element 20 is rotated such that the respective focus spots are at the centers of the corresponding light-receiving elements in the direction of rotation is the best e value, then there will be a best θ value for each distance (Z balance value) between the light-splitting element 20 and the light-receiving unit 30.

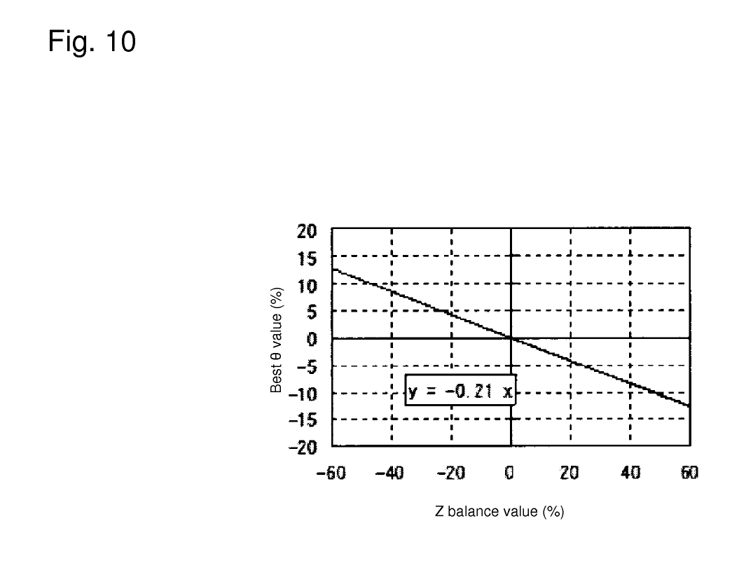

The relationship between the Z balance value and the best θ value will be described with reference to drawings. FIG. is a diagram showing the relationship between the best θ value and the Z balance value of the optical pickup according to a preferred embodiment of the present invention. The Z balance value shown in FIG. 10 becomes zero when the distance between the light-splitting element 20 and the light-receiving unit 30 is the distance determined by the design. When the distance is longer than the design distance, the Z balance value becomes positive; when the distance is shorter, the value becomes negative. Furthermore, the relationship between the best e value and the Z balance value is determined by the shapes of the light-splitting element 20 and light-receiving unit 30. In the optical pickup 1, the relationship is expressed by the following equation:

Best θ value=−0.21×Z balance value

Moreover, the best θ value preferably is obtained based on the Z balance value by utilizing the equation described above or the graph shown in FIG. 10 when assembling the optical pickup 1. Therefore, the position of the light-splitting element 20 in the direction of rotation centered on the optical axis of the zeroth-order light is adjusted by utilizing this relationship between the Z balance value and the best θ value. Mounting of the light-splitting element 20 and the adjustment of its position will be described.

When assembling the optical pickup 1, the light-receiving unit 30 is first secured in its specified mounting position. Then, the light-splitting element 20 is provisionally fixed in its predetermined mounting position. Then, the return light (or light equivalent to it) is caused to be incident on the light-splitting element 20, and the light is received by the light-receiving unit 30. At this time, the position-adjustment light LB3 is received by the light-receiving elements 37a through 37d. The Z balance value is then calculated from the received position-adjustment light LB3. At this point, the e balance value is also calculated.

The best θ value is calculated based on the graph shown in FIG. 10 or the equation described above. Then, the light-splitting element 20 is rotated such that the θ balance value becomes the best θ value, and the light-splitting element 20 is secured in place in a state in which the θ balance value is the best θ value.

Even when the mounting positions of the light-splitting element 20 and the light-receiving unit 30 vary, an optical pickup in which the precision of the TE signal is not prone to decline due to external disturbances is manufactured by making adjustments in this manner. If this is done, it is possible to prevent or significantly reduce the occurrence of read faults of signals caused by individual differences between optical pickups 1.

Note that the relational expression is an equation derived based on the relationship between the best θ value and the Z balance value shown in FIG. 10. In the present preferred embodiment, the θ balance value and the Z balance value have a proportional relationship, but the relationship does not necessarily result in such a proportional relationship.

Preferred embodiments of the present invention were described above, but the present invention is in no way limited to these contents. In addition, a variety of alterations can be made to the preferred embodiments of the present invention as long as they do not depart from the gist of the present invention.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An optical pickup comprising:
a light-splitting element configured to split return light reflected by a recording surface of an optical disc and to scatter signal light used in signal processing and position-adjustment light that is not used in signal processing in different directions other than a direction of an optical axis of zeroth-order light; and
a light-receiving unit configured to receive each of the signal light and position-adjustment light generated by the light-splitting element; wherein
an adjustment-light light-receiving unit configured to detect the position-adjustment light and provided on a light-receiving surface of the light-receiving unit, the adjustment-light light-receiving unit includes quartered light-receiving portions defined by equal quartering so as to be arranged in two dimensions; and
a position of the light-splitting element is adjusted based on the position-adjustment light received by each of the quartered light-receiving portions.

2. The optical pickup according to claim 1, wherein the signal light includes a first signal light which includes interference light caused by a track groove of the optical disc and a second signal light which does not include interference light caused by the track groove of the optical disc; and
the light-splitting element is configured such that a focal position of the position-adjustment light on the light-receiving surface is located between a focal position of the first signal light and a focal position of the second signal light in a circumferential direction that is centered on a focal position of the zeroth-order light.

3. The optical pickup according to claim 1, wherein the adjustment-light light-receiving unit is divided into the quartered light-receiving portions by a first dividing line that extends in a circumferential direction centered on a focal position of the zeroth-order light and a second dividing line that extends in a radial direction centered on the focal position of the zeroth-order light.

4. The optical pickup according to claim 3, wherein
the quartered light-receiving portions are each configured to quantize and output a surface area of irradiated light; and
a position of the light-splitting element is adjusted based on a Z balance value which represents a shift in a distance between the light-splitting element and the light-receiving element and which is calculated based on surface areas of the irradiated light that are respectively output by the quartered light-receiving portions and a θ balance value which represents a shift in a direction of rotation centered on the optical axis of the zeroth-order light and which is calculated based on surface areas of irradiated light that are respectively output by the quartered light-receiving portions.

5. The optical pickup according to claim 4, wherein
an adjustment target value is determined for the θ balance value according to the Z balance value; and
the position of the light-splitting element is adjusted such that the θ balance value becomes the adjustment target value.

6. The optical pickup according to claim 4, wherein the position of the light-splitting element is adjusted such that the Z balance value becomes 0 and the θ balance value becomes 0 by moving the light-splitting element in the direction of the optical axis of the zeroth-order light and also causing the light-spitting element to rotate centered on the optical axis of the zeroth-order light.

7. The optical pickup according to claim 1, wherein
the light-splitting element includes a plurality of diffraction gratings configured to split and scatter the signal light and the position-adjustment light in directions different from the optical axis of the zeroth-order light; and
the diffraction grating for the position-adjustment light is located in an area of the light-splitting element through which a center portion of the return light from the optical disc passes.

8. The optical pickup according to claim 1, wherein the light-splitting element is a hologram element.

9. The optical pickup according to claim 1, wherein the light-receiving unit includes a cylindrical lens and a plurality of light-receiving elements.

10. The optical pickup according to claim 9, wherein the cylindrical lens is configured to focus light in one direction only.

11. The optical pickup according to claim 9, wherein the cylindrical lens is a sensor lens configured to generate a focus error signal.

12. The optical pickup according to claim 9, wherein the plurality of light-receiving include photodiodes.

13. The optical pickup according to claim 1, wherein the light-splitting element includes a rectangular or substantially rectangular light-receiving surface configured to include a plurality of diffraction areas.

14. The optical pickup according to claim 13, wherein the plurality of diffraction areas have different shapes from each other.

15. The optical pickup according to claim 1, wherein the light-splitting element is divided into a plurality of equal portions in an X direction and a plurality of equal portions in a Y direction.

16. The optical pickup according to claim 1, wherein the adjustment-light light-receiving unit includes four light-receiving elements having the same size or substantially the same size.

17. The optical pickup according to claim 16, wherein the four light-receiving elements each are square or substantially square and arranged in a two-by-two matrix.

18. An optical disc device comprising the optical pickup according to claim 1, wherein the optical pickup is configured to irradiate an optical disc with light, detect light reflected by the optical disc, and perform playback control of the optical disc.
